(19) United States
(12) Patent Application Publication
(10) Pub. No.: US 2026/0270752 A1
(43) Pub. Date: Sep. 10, 2026

(54) SYSTEMS AND METHODS FOR ARTIFICIAL INTELLIGENCE AND MACHINE LEARNING MODELS USING MEASUREMENT DATA OF DIFFERENT FORMATS

(71) Applicant: Telefonaktiebolaget LM Ericsson (PUBL), Stockholm (SE)

(72) Inventors: Jung-Fu CHENG, FREMONT, CA (US); Yufei Blankenship, KILDEER, IL (US)

(21) Appl. No.: 19/473,226

(22) PCT Filed: Apr. 8, 2024
(86) PCT No.: PCT/IB2024/053437

§ 371 Date: Oct. 7, 2025

Related U.S. Application Data
(60) Provisional application No. 63/457,862, filed on Apr. 7, 2023.

(51) Int. Cl. H04W 24/10; G06N 20/00; H04W 24/08

(52) U.S. Cl. CPC H04W 24/10; G06N 20/00; H04W 24/08

(57) ABSTRACT

A method (1400) by a radio node (710) operating as a signal measurement entity for providing measurement data of different formats for an Artificial Intelligence, AI, and/or Machine Learning, ML, model includes generating (1402) at least one measurement data sample. The radio node sends (1404) to at least one other entity: the at least one measurement data sample for use as training data for the AI and/or ML model; and for each measurement data sample, at least one format parameter of the associated measurement data sample.

### TECHNICAL FIELD

The present disclosure relates, in general, to wireless communications and, more particularly, systems and methods for Artificial Intelligence (AI) and Machine Learning (ML) models using measurement data of different formats.

### BACKGROUND

Artificial Intelligence (AI) and Machine Learning (ML) have been investigated as promising tools to optimize the design of air-interface in wireless communication networks in both academia and industry. Example use cases include: using autoencoders for Channel State Information (CSI) compression to reduce the feedback overhead and improve channel prediction accuracy; using deep neural networks for classifying Line-of-Sight (LOS) and No-Line-of-Sight (NLOS) conditions to enhance the positioning accuracy; using reinforcement learning for beam selection at the network side and/or the User Equipment (UE) side to reduce the signaling overhead and beam alignment latency; and using deep reinforcement learning to learn an optimal precoding policy for complex Multiple Input Multiple Output (MIMO) precoding problems.

In 3^{rd} Generation Partnership Project (3GPP) New Radio (NR) standardization work, a Release 18 study item was initiated for AI/ML for NR air interface. This study item explores the benefits of augmenting the air-interface with features enabling improved support of AI/ML based algorithms for enhanced performance and/or reduced complexity/overhead. Through studying a few selected use cases such as, for example, CSI feedback, beam management and positioning, this System Information (SI) aims at laying the foundation for future air-interface use cases leveraging AI/ML techniques.

Building an AI/ML model includes several development steps where the actual training of the AI model is just one step in a training pipeline. An important part in AI/ML developing is the AI/ML model lifecycle management, which is illustrated in FIG. 1. More specifically, FIG. 1 provides an illustration of training and interference pipelines, and their interactions within a model lifecycle management procedure.

As depicted in FIG. 1, the AI model lifecycle management typically consists of:
a training (re-training) pipeline,
   With data ingestion referring to gathering raw (training) data from a data storage. After data ingestion, there may also be a step that controls the validity of the gathered data.
   With data pre-processing referring to some feature engineering applied to the gathered data. For example, it may include data normalization and possibly a data transformation required for the input data to the AI/ML model.
   With the model training steps.
   With model evaluation referring to benchmarking the performance to some baseline. The iterative steps of model training and model evaluation continues until the acceptable level of performance (as previously exemplified) is achieved.
   With model registration referring to register the AI/ML model, including any corresponding AI/ML-meta data that provides information on how the AI/ML model was developed, and possibly AI/ML model evaluations performance outcomes.
a deployment stage to make the trained (or re-trained) AI/ML model part of the inference pipeline,
an inference pipeline,
   With data ingestion referring to gathering raw (inference) data from a data storage.
   With data pre-processing stage that is typically identical to corresponding processing that occurs in the training pipeline.
   With model operational referring to using the trained and deployed model in an operational mode.
   With data & model monitoring referring to validate that the inference data are from a distribution that aligns well with the training data, as well as monitoring model outputs for detecting any performance, or operational, drifts.
a drift detection stage that informs about any drifts in the model operations.

In a first scenario, we assume that AI/ML models operating with the existing standard air-interface are placed at the UE side. A UE uses the AI/ML models to generate output that is reported to a centralized node in the network for positioning the UE location.

In a second scenario, we assume AI/ML models operating with the existing standard air-interface are placed at different Transmit/Receive Points (TRPs). A TRP uses the AI/ML models to generate output that is reported to a centralized node in the network for positioning the UE location.

### Measurements of Different Accuracy Requirements and Different Reporting Mapping Resolutions

For radio signal measurements, often different measurement accuracy levels are achievable depending on the signal configuration such as, for example, bandwidth, Signal Interference to Noise Ratio (SINR), Additive White Gaussian Noise (AWGN) versus fading channel condition, etc.

Accordingly report mapping of the signal measurements are defined with different level of resolution step sizes. Timing related measurement is a typical example of such radio signal measurement.

This phenomenon exists for UE-side measurements, as well as gNodeB-side measurements.

### UE-Side Measurements of Different Accuracy Requirements

3GPP Release 16/Release 17 provide UE-side measurement accuracy tables. The UE Receiver (Rx)-Transmitter (Tx) time difference measurement accuracy is an example. For example, Table 10.1.25.2-2 of R4-2115310 provides UE Rx-Tx time difference measurement accuracy in Frequency Range 1 (FR1) for fading. Likewise, Table 10.1.25.2-3 of R4-2115310 provides UE Rx-Tx difference measurement accuracy in Frequency Range 2 (FR2) in AWGN._It is observed that UE Rx-Tx time difference measurement accuracy requirement has a wide range, from (±4+δ)*T_{c} in FR2 in AWGN to (±180+δ)*T_{c} in FR2 in fading channel.

Similar tables exist for other types of measurements (e.g., Reference Signal Time Difference (RSTD)) on the UE side, as well as measurements performed by gNB.

### UE-Side Measurement Report with Different Resolutions

The reporting range for the absolute UE Rx-Tx time difference measurement (TUE Rx-Tx) is defined from −985024×T_{c} to 985024×T_{c} with the resolution step of 2^{k}×T_{c}.

The TUE Rx-Tx report mapping for k=0, 1, 2, 3, 4, and 5 are specified in 3GPP TS 38.133 v 18.0.0. Here Te is the basic timing unit used in NR, T_{c}=1/(Δfₘₐₓ·N_{f})=0.51 ns, where Δfₘₐₓ=480·10³ Hz and N_{f}=4096.

There currently exist certain challenges, however. For example, training or inference data may be measured with different format parameters such as: resolution, value range, sampling rate, and sample grid shifts. The parameter variation occurs if the training or inference data is collected from different sources (e.g., different devices), at different times, at different cells (e.g., large cell vs small cell), at different locations (e.g., indoor vs outdoor), and/or different deployment scenarios or different radio configurations (e.g., Time Division Duplex (TDD)/Frequency Division Duplex (FDD), signal bandwidth, carrier frequency, etc.). Without sufficient reporting and recording methods, collected data cannot be used in AI/ML model training or model inference correctly.

Traditionally, the dataset may be trimmed such that only compatible measurement data are retained. Such trimming wastes already collected training data and results in inferior AI/ML models from model training.

In the worst case, data were collected without recording the corresponding format parameters of the measurement. AI/ML model training or interference using such data can result in non-performing models and incorrect inference outputs.

### SUMMARY

Certain aspects of the disclosure and their embodiments may provide solutions to these or other challenges. For example, methods and systems are provided for coordinating the reporting, recording, and/or conversion of data collected with heterogenous parameters to enable correct reformatting of all collected measurement data to suit the intended AI/ML model training or inference.

According to certain embodiments, a method by a radio node operating as a signal measurement entity for providing measurement data of different formats for an AI and/or ML model includes generating at least one measurement data sample. The radio node sends, to at least one other entity, the at least one measurement data sample for use as training data for the AI and/or ML model. The radio node also sends, for each measurement data sample, at least one format parameter of the associated measurement data sample.

According to certain embodiments, a radio node operating as a signal measurement entity for providing measurement data of different formats for an AI and/or ML model is configured to generate at least one measurement data sample. The radio node is configured to send, to at least one other entity, the at least one measurement data sample for use as training data for the AI and/or ML model. The radio node also is configured to send, for each measurement data sample, at least one format parameter of the associated measurement data sample.

According to certain embodiments, a method by a radio node operating as a model inference entity, a training data collection entity, or a model training entity for receiving measurement data of different formats for an AI and/or ML model includes receiving, from another radio node operating as a signal measurement entity, at least one measurement data sample for training the AI and/or ML model. The radio node also receives, for each measurement data sample, at least one format parameter of the associated measurement data sample.

According to certain embodiments, a radio node operating as a model inference entity, a training data collection entity, or a model training entity for receiving measurement data of different formats for an AI and/or ML model is configured to receive, from another radio node operating as a signal measurement entity, at least one measurement data sample for training the AI and/or ML model. The radio node is also configured to receive, for each measurement data sample, at least one format parameter of the associated measurement data sample.

Certain embodiments may provide one or more of the following technical advantages. For example, certain embodiments may provide a technical advantage of, with respect to training data collection, allowing measurement data to be collected with varying formats, so that the measurement of wireless signal can be collected with minimum overhead and with minimum loss of measurement accuracy. It is known that the best achievable measurement accuracy of the wireless signals can vary widely as a function of numerous configuration and implementation factors.

As another example, certain embodiments may provide a technical advantage of supporting model training with measurement data of varying format parameters. Measurement data collected with heterogeneous formats can all be included for the training of the AI/ML model. When the training dataset size is maximized, AI/ML models with better performance can be obtained. Moreover, for a given training dataset, the systems and methods also support constructing models to ingest measurement data of a preferred format, where multiple formats are possible, and the preferred format chosen for a model can vary depending on the design targets of the model.

As yet another example, with respect to model training, certain embodiments provide a technical advantage of allowing the deployed model to ingest measurement data of varying formats.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates training and interference pipelines and their interactions within a model lifecycle management procedure;

FIG. 2 illustrates an example procedure for collecting training data and perform model training, according to certain embodiments;

FIG. 3 illustrates an example procedure for performing model inference at the model inference entity, according to certain embodiments;

FIG. 4 illustrates a power delay profile (PDP) for a line-of-sight (LOS) channel, according to certain embodiments;

FIG. 5 illustrates a PDP for a non-line-of-sight (NLOS) channel, according to certain embodiments;

FIG. 6 illustrates a sub-sampled PDP, according to certain embodiments;

FIG. 7 illustrates an example DP, according to certain embodiments;

FIG. 8 illustrates an example communication system, according to certain embodiments;

FIG. 9 illustrates an example UE, according to certain embodiments;

FIG. 10 illustrates an example network node, according to certain embodiments;

FIG. 11 illustrates a block diagram of a host, according to certain embodiments;

FIG. 12 illustrates a virtualization environment in which functions implemented by some embodiments may be virtualized, according to certain embodiments;

FIG. 13 illustrates a host communicating via a network node with a UE over a partially wireless connection, according to certain embodiments;

FIG. 14 illustrates an example method by a radio node for handling measurement data of different formats for an AI and/or ML model, according to certain embodiments;

FIG. 15 illustrates an example method by a radio node operating as a signal measurement entity for providing measurement data of different formats for an AI and/or ML model, according to certain embodiments; and

FIG. 16 illustrates an example method by a radio node operating as a model inference entity, a training data collection entity, or a model training entity for receiving measurement data of different formats for an AI and/or ML model, according to certain embodiments.

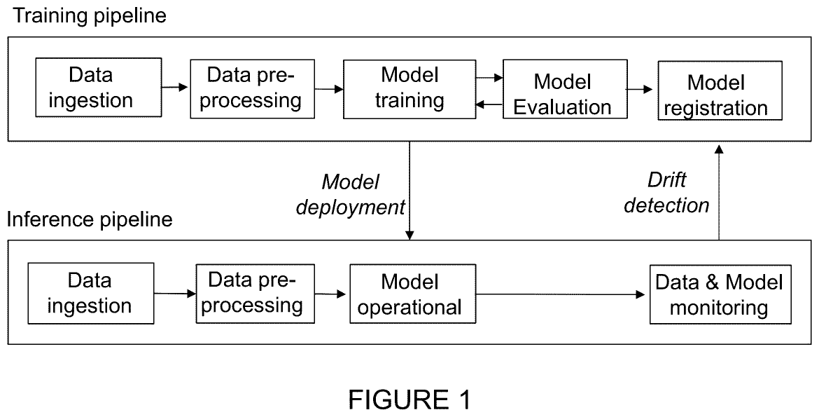

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ or ‘radio node’ can be a network node or a UE. In some embodiments a general term “network node” is used and it can correspond to any type of radio network node or any network node, which communicates with a UE and/or with another network node. Examples of network nodes are NodeB, base station (BS), a network node belonging to MCG or SCG, multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, D2D UE to network relay, donor node controlling relay, base transceiver station (BTS), Central Unit (e.g. in a gNB (gNB-CU)), Distributed Unit (e.g. in a gNB (gNB-DU)), Baseband Unit, Centralized Baseband, C-RAN, access point (AP), transmission points (TP), transmission nodes, transmission and reception points (TRPs), Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), location server, location management entity (LMF), MDT, etc.

Another example of a node is user equipment (UE), which is a non-limiting term and refers to any type of wireless device communicating with a network node and/or with another UE over radio signals such as, for example, in a cellular or mobile communication system. Examples of UE are radio communication device, target device, device to device (D2D) UE, vehicular to vehicular (V2V), machine type UE, MTC UE or UE capable of machine to machine (M2M) communication, low-cost and/or low-complexity UE, a sensor equipped with UE, Personal Digital Assistant (PDA), Tablet, mobile terminals, smart phone, laptop embedded equipment (LEE), laptop mounted equipment (LME), Unified Serial Bus (USB) dongles, Customer Premises Equipment (CPE), an Internet of Things (IOT) device, or a Narrowband IoT (NB-IOT) device, etc. The terms UE and wireless device are used interchangeably.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of downlink (DL) physical signals are reference signal (RS) such as Primary Synchronization Signal (PSS), Secondary Synchronization Signal (SSS), Channel State Information-Reference Signal (CSI-RS), Demodulation Reference Signal (DMRS) signals in SS/PBCH block (SSB), discovery reference signal (DRS), Cell Specific Reference Signal (CRS), Positioning Reference Signal (PRS), etc. RS may be periodic. For example, RS occasions carrying one or more RSs may occur with certain periodicity (e.g., 20 ms, 40 ms, etc.). The RS may also be aperiodic.

Each SSB carries New Radio-Primary Synchronization Signal (NR-PSS), New Radio-Secondary Synchronization Signal (NR-SSS) and New Radio-Physical Broadcast Channel (NR-PBCH) in four successive symbols. One or multiple SSBs are transmitted in one SSB burst which is repeated with certain periodicity such as, for example, 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's SFN) etc. Therefore, SMTC occasion may also occur with certain periodicity (e.g., 5 ms, 10 ms, 20 ms, 40 ms, 80 ms, and 160 ms). Examples of uplink (UL) physical signals are reference signals such as Sounding Reference Signals (SRS), Demodulation Reference Signals (DMRS), etc. The term physical channel refers to any channel carrying higher layer information e.g. data, control etc. Examples of physical channels are Physical Broadcast Channel (PBCH), Physical Downlink Control Channel (PDCCH), Physical Downlink Shared Channel (PDSCH), Physical Uplink Shared Channel (PUSCH), Physical Uplink Control Channel (PUCCH), Physical Uplink Shared Channel (PUSCH), Short PUSCH (sPUCCH), Short PDSCH (SPDSCH), Short PUCCH (sPUCCH), Short PUSCH (sPUSCH), MTC PDCCH (MPDCCH), Narrowband PBCH (NPBCH), Narrowband PDCCH (NPDCCH), Narrowband PDSCH (NPDSCH), Narrowband PUSCH (NPUSCH), Enhanced PDCCH (E-PDCCH), etc.

The term time resource used herein may correspond to any type of physical resource or radio resource expressed in terms of length of time. Examples of time resources are: symbol, time slot, subframe, radio frame, Transmission Time Interval (TTI), interleaving time, slot, sub-slot, mini-slot, system frame number (SFN) cycle, hyper-SFN (H-SFN) cycle etc.

According to certain embodiments, methods for supporting AI/ML with model input of various format parameters are described. For the purposes of analysis, the timing measurement is used to illustrate the necessity of supporting measurements of model input with different format parameters. While this is a typical model input of AI/ML for wireless communication, this is a non-limiting example and is used only to illustrate the methodology. It is understood by those skilled in the art that the same methodologies and design principles can be extended to many other type of measurements such as, for example, Reference Signal Received Power (RSRP), Layer 1-Signal Interference to Noise Ratio (L1-SINR), etc.

According to certain embodiments associated with the reporting of training data samples associated with measurements of wireless signals, the measurement data is reported together with its format parameters. The format parameters provide the information for correctly interpreting the reported measurement data. Typical format parameters include, for example, the value range and the quantization resolution of the measurement data.

According to certain embodiments associated with model training, the training data samples of different format parameters are pre-processed so that the training data sample values for the model input are converted to the same format chosen for the model, for example, the same value range and quantization resolution.

According to certain embodiments associated with model inference, the measurement data for model input are pre-processed so that the measurement data values are converted to the format used by the model.

It is also noted that the disclosed methodologies and design principles can be applied to AI/ML model deployed in various entities in the wireless communications network, including but not limited to: a UE and/or a network node.

Training Data Collection with Measurements of Different Levels of Resolutions For model input that includes measured timing info such as, for example delay profile (DP), PDP, and/or channel impulse response, the achievable timing measurement accuracy is a function of various factors such as, for example, FR1 vs FR2, Subcarrier Spacing (SCS), Reference Signal Bandwidth (RS BW), RS repetition, etc.

For example, with regard to RS BW, a fundamental limitation is that the theoretically best possible timing detection accuracy (in seconds) is 1/Bandwidth. Thus, bandwidth (BW) is a fundamental limitation to achievable accuracy, irrespective of UE hardware implementation. Also SCS of the reference signal significantly affects the achievable timing accuracy, where higher timing detection accuracy is achievable with higher SCS.

For UE-side RxTxTimeDiff, numerous UE RxTxTimeDiff accuracy tables are specified in NR, and the accuracy requirement has a wide range, from (±4+δ)*T_{c} in FR2 in AWGN to (±180+δ)*T_{c} in FR1 in fading channel. Correspondingly, T_{UE Rx-Tx} report mapping tables for k=0, 1, 2, 3, 4, and 5 are provide for UE to report RxTxTimeDiffimeDiff, each table with a resolution step of 2^{k}×T_{c}.

Similar tables exist for other UE side timing measurements, e.g., RSTD.

For the network side, the same issues exist. Consequently, gNB side timing measurements also have several levels of resolution in report mapping, including Uplink-Relative Time of Arrival (UL-RTOA) and gNB RxTxTimeDiff.

Considering the different levels of achievable measurement accuracy and different levels of resolution for report mapping, it is clear that radio signal measurements for training data collection will contain measurements of a range of format parameters (e.g., resolutions). Several factors contribute to this when considering measurement data collected from UE:
A same UE may be configured with DL reference signals of various parameter setting, and deployed in various scenarios. Numerous factors affect the achievable measurement accuracy, including:
   various frequency range (e.g., FR1 vs FR2)
   various SCS of the DL RS,
   various DL reference signal bandwidth,
   various number of repetitions of the DL reference signal,
   AWGN vs fading channel condition.
Different UEs may have different capabilities. Thus for UEs in the same deployment scenario, the achievable measurement accuracy can be different for different UEs. Such UE capabilities include:
   Supported frequency range (e.g., FR1 vs FR2),
   Supported maximum DL reference signal bandwidth,
   Supported number of carriers,
   Supported SCS value(s) of the DL RS,
   The achievable SINR due to different receiver implementation in the UE (e.g., with or without inference cancellation),
   UE types (e.g., normal capability UE vs Reduced Capability UE (RedCap UE)).

Similar factors exist for the measurements made by the network nodes.

Thus there is a need to have signalling design that take into account the varying formats in measurement data collection.

For UE-side model, to report UE measurements as AI/ML model training data, it is important to reduce training data entry size to reduce signalling overhead. Thus different UE (or positioning reference unit (PRU)) should be allowed to use different parameter settings to report data for training data collection. Examples of the parameter settings include one or more of the following:
(a) the range (Tₘᵢₙ, Tₘₐₓ) of the reported values in floating point (i.e., before quantization),
(b) the range (T_{q,min}, T_{q,max}) of reported values in fixed point (i.e., after quantization)
(c) k for the resolution of report mapping (i.e., quantization step size, assuming uniform quantization).

According to certain embodiments, at least two of the above described types of information are signalled, together with the measurement data report, so that measurements of varying resolution can be aligned to a common format, if necessary. In a particular embodiment, if the relationship between (a) and (b) is pre-defined with mapping tables, and the tables are indexed via k, only signal (c) may be signaled with the measurement data report.

It is noted that, for the range of reported values, it is possible to indicate the range using one value instead of two, in a particular embodiment. For example, a relationship can be pre-defined between Tₘᵢₙ and Tₘₐₓ, for instance: Tₘᵢₙ=−Tₘₐₓ. In this case, the range is (−Tₘₐₓ, Tₘₐₓ) and can be indicated via Tₘₐₓ. Alternatively, one of the two values can be given a fixed value, for instance: Tₘᵢₙ=0. In this case, the range is (0, Tₘₐₓ) and can be indicated via Tₘₐₓ. Similar consideration applies for the quantized range (T_{q,min}, T_{q,max}).

The goal is to ensure that measurement data of a certain level of accuracy is reported with a corresponding level of resolution, where the signalling overhead is kept low without sacrificing the accuracy of the measurement data. For example, a value with measurement accuracy of 32*Tc should be reported with resolution of 32*Tc, not 4*Tc (which uses an unnecessarily large number of bits to represent coarse values) or 128*Tc (which uses too few number of bits in reporting and the measurement data accuracy is unnecessarily degraded due to coarse reporting).

According to certain embodiments, the parameters that determine the number of bits in measurement data reporting may be configured at the start of training data collection and recorded as part of the training data. In various particular embodiments, such parameters include one or more of the following.
(1) The k value is selected for the measurement, and the k values are reported together with the measurement data. Here the (2^{k}*T_{c}) is the resolution of reported timing values.
   If the k value does not change frequently, then either a network node configures the k value for the UE, or the UE selects a proper k value for its measurement report, according to particular embodiments. The k value selection step may be done during the preparation phase which initiates the training data collection session. In one example, the selected k value is recorded in a header of the training data report, or as part of the meta data for the given training data collection session.
   If the k value can change during a training data collection session, then the k value can be recorded for each training data sample.
(2) The timing value range (Tₘᵢₙ, Tₘₐₓ) (or (T_{q,min}, T_{q,max})) is selected for the measurement and reported together with the measurement data. Either a network node configures the value range for the UE, or the UE selects a proper range for its measurement report. The timing value range may vary according to the current cell radius size. For example, a smaller timing value range may be used for smaller cells, and a larger timing value range may be used to support larger cells. In one example, the selected timing value range is recorded in a header of the training data report or as part of the meta data for the given training data collection session.

According to certain embodiments, for training data storage, the collected measurement data of varying resolution are stored as is. For example, the measurement data samples are stored together with their value range and resolution parameters as UE reported. Alternatively, in other embodiments, the measurement data is converted to a common format for storage. For example, in a particular embodiment, all measurement data are converted to a format according to kₛₜₒᵣₑ, (T_{store,min}, _{Tstore,max}) (or (T_{q,store,min}, T_{q,store,max})

### Model Training with Measurement Data of Different Resolutions

According to certain embodiments, to perform model training and model compilation, pre-processing of the timing values is done so that all timing values are converted to the same format that has been chosen for the model. In a particular embodiment, the parameters used in the pre-processing include:
value range (T_{model,min}, T_{model,max}) or (T_{q,model,min}, T_{q,model,max}),
k_{model} for the resolution of model input values: 2^{k}^{_{model}}×T_{c}.

Thus, after pre-processing, all timing values measured for model input conform with the same format of the given model.

According to certain embodiments, the pre-processing of the reported timing values with different parameters for the measurement to the same format for the ML model include:
resampling of the reported timing values from a first sampling resolution, kₛₜₒᵣₑ, used for the measurement sample storage, to a second sampling resolution, k_{model}, for the ML model; and/or
resampling of the reported timing values with respect to a first starting timing, T_{store,min}, for the measurement sample storage, to timing values with respect to a second starting timing, T_{model,min}, for the ML model.

In a particular example embodiment, the resampling of the reported timing values with different parameters for the measurement consists of:
determining an up-sampling factor Fᵤ and a down-sampling factor F_{d} based on at least the ratio of 2^{k}^{_{model}}/2^{k}^{ₛₜₒᵣₑ} or, equivalently, 2^{k}^{_{model}}^{-k}^{ₛₜₒᵣₑ};
inserting between the reported timing values with Fᵤ−1 zeros to obtain an intermediate up-sampled sequence;
low-pass filtering said intermediate up-sampled sequence to obtain a filtered sequence; and/or
down-sampling said filtered sequence by retaining every F_{d}-th sample from the filtered sequence.

In the above example, the factor Fu and Fa are positive integers such that Fᵤ/F_{d} is as close to 2^{k}^{_{model}}^{-k}^{ₛₜₒᵣₑ} as possible.

In the above example, said down-sampling of said filtered sequence starts retaining every F_{d}-th sample from an index determined based on at least said first starting timing, T_{store,min}, for the measurement and said second starting timing, T_{model,min}, for the ML mode.

For the format used to train and compile the model, UEs of different capabilities may wish to use different format parameters k_{model} and (T_{model,min}, T_{model,max}). For example, UEs with more advanced chip can use smaller k_{model} and larger (T_{model,min}, T_{model,max}) to have higher accuracy, even though the final model can be more complex for hardware implementation. Alternatively, a UE can opt for larger k_{model} and smaller (T_{model,min}, T_{model,max}) to trade accuracy for model hardware efficiency. Thus for a same stored training data set, the data can be truncated/quantized differently for training different models of different UE categories.

Since the format parameters k_{model}, (T_{model,min}, T_{model,max}) ; and (T_{q,model,min}, T_{q,model,max}) are critical context information for the trained AI/ML model, they need to be saved as part of the meta data for the model. If the model needs to be sent from one entity (e.g., model depository server) to another entity (e.g., model inference entity), such context information of format parameters need to be sent together with the model itself.

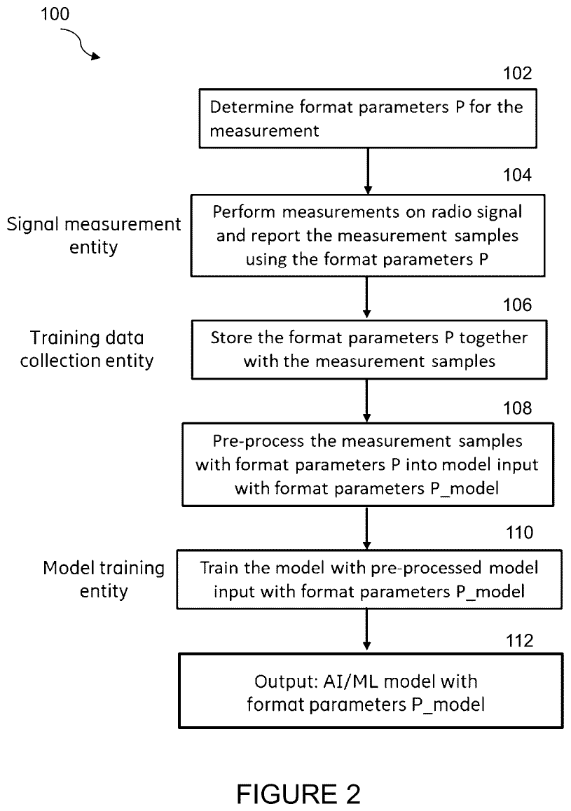

FIG. 2 illustrates an example procedure 100 for collecting training data and perform model training, according to certain embodiments. Specifically, FIG. 2 illustrates an example procedure for when the measurement data is of different formats and/or has different format parameters (e.g., resolutions and/or value ranges).

As illustrated, the procedure 100 begins at step 102 when the format parameters P for the measurement are determined. At step 104, a signal measurement entity performs measurements on a radio signal and reports the measurement samples using the format parameters P. At step 106, the training data collection entity stores the format parameters P together with the measurement samples. At step 108, the training data collection entity pre-processes the measurement samples with format parameters P into model input with format parameters P_model. At step 110, the model training entity trains the model with pre-processed model input with format parameters P_model. Finally, at step 112, the AI/ML model with format parameters P_model is output.

According to certain embodiments, parameters P and P_model each include the full set of format parameters necessary for interpreting the measurement and may include, for example, value range and/or the resolution of the measurement values.

Model Inference with Measurement Data of Different Resolutions During model inference, the measurement data used for model input need to use the format that was used in model training and model compilation. That is, the model input at model inference need to use k_{model} and (T_{model,min}, T_{model,max}) of the model being activated for the given UE. If the actual measurement resolution and value range of measurement data for model inference are different from those of the activated model, then data format conversion needs to be done as part of the data pre-processing step.

As noted earlier, if the UE has received the model from another entity via model transfer or model delivery, the UE is the model inference entity and should have received those format parameters (e.g., k_{model}, (T_{model,min}, T_{model,max}), (T_{q,model,min}, T_{q,model,max})) together with the model.

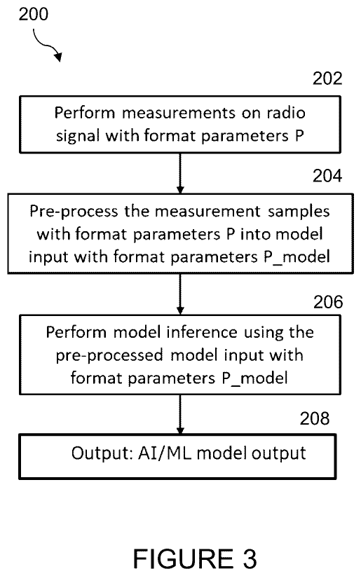

FIG. 3 illustrates an example procedure 200 for performing model inference at the model inference entity, according to certain embodiments. As illustrated, the procedure 200 begins at step 202 when measurements are performed on radio signal with format parameters P. At step 204, the measurement samples with format parameters P are pre-processed into model input with format parameters P_model. At step 206, model inference is performed using the pre-processed model input with format parameters P_model. At step 208, the AI/ML model output is generated and output.

The measurement data at model inference stage may have different format parameters (e.g., resolutions and/or value range) than those of the deployed model. The deployed model was trained and compiled with format parameters P_model. P_model may not be the same as P.

### Example Applications

For an AI/ML based positioning use case, timing information of received radio propagation paths is very important and is frequently included as AI/ML model input. The most frequency used AI/ML model input include channel impulse response (CIR), power delay profile (PDP), and delay profile (DP).

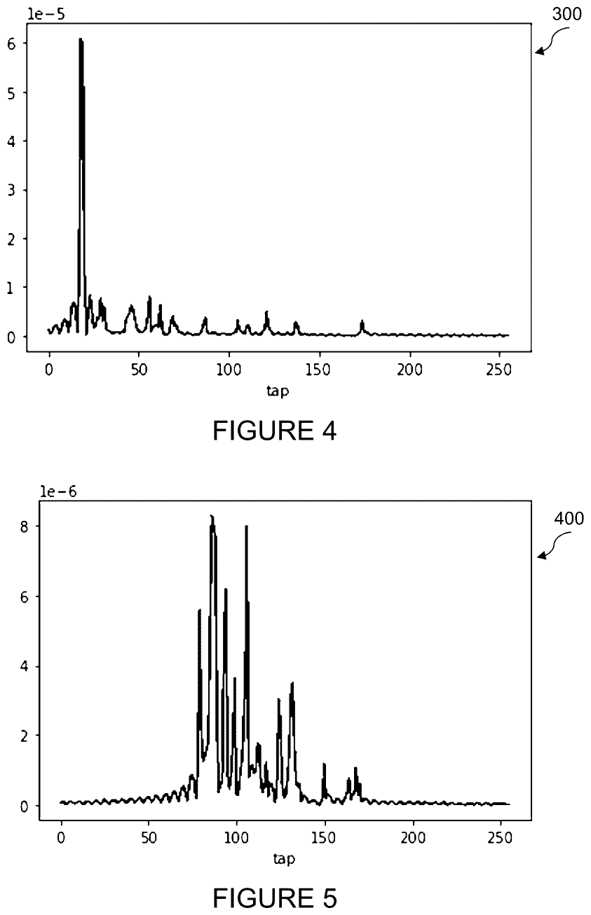

Channel impulse response (CIR) provides rich information about the radio link. As a smaller size alternative, PDP can be used instead of CIR. FIG. 4 illustrates a PDP 300 for a LOS channel, according to certain embodiments.

FIG. 5 illustrates a complete PDP 400 for a NLOS channel, according to certain embodiments.

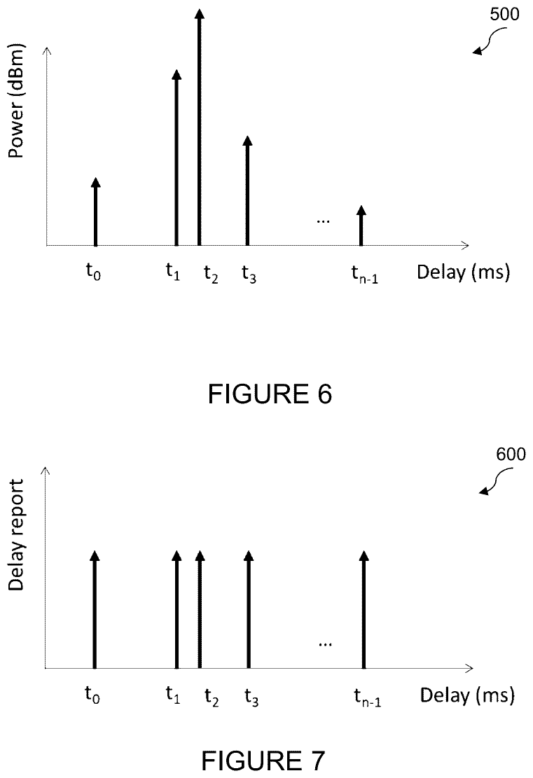

To reduce measurement and reporting burden, sub-sampled PDP can be used instead of the complete PDP, where only the strongest taps are kept. FIG. 6 illustrates a sub-sampled PDP 500, according to certain embodiments.

When PDP is used for one radio link, for the time window containing a total of N sample and n received paths, two values are measured and reported for each of the n received paths:
(a) The arrival time of the i-th path, {t₀, t₁, t₂, . . . , tₙ₋₁} and
(b) The power of the i-th path, {P₀, P₁, P₂, . . . , Pₙ₋₁}, i=0, 1, . . . , n−1.

To further reduce the size of information for describing the observed paths, DP can be used instead of PDP. That is, the power aspect of each path can be ignored, and only the timing information of each paths is kept: t₀, t₁, t₂, . . . , tₙ₋₁. FIG. 7 illustrates an example DP 600, according to certain embodiments. It can be viewed as a reduced description of the sub-sampled PDP illustrated in FIG. 6.

When CIR, PDP, DP or their modified versions (e.g., RSTD, UE RxTxTimeDiff, gNB RxTxTimeDiff) are used as AI/ML model input, timing information of received radio paths need to be detected by the receiver. The receiver performs the detection by observing the reference signal.
For NR DL, the reference signals include: SSB, CSI-RS, tracking reference signal (TRS), phase-tracking reference signal (PTRS), positioning reference signal (PRS), etc. The UE attempts to obtain the radio path timing information by receiving one or more instances of the downlink reference signals.
For NR UL, the reference signals include: SRS and PTRS. The base station attempts to obtain the radio path timing information by receiving one or more instances of the UL reference signals. The base station is also referred to as network node, gNB, transmission reception point (TRP), reception point (RP).

For both UL and DL, the achievable timing detection accuracy varies with several factors, including frequency range (e.g., FR1 vs FR2), SCS, and bandwidth of the reference signal, the received signal quality (e.g., Ês/Iot, SINR, RSRP).

Because measurements of different levels of resolution need to be handled when used as AI/ML model input, certain methods and systems described herein are applied to the training data collection, model training, and/or model inference for the AI/ML models designed for physical layer applications.

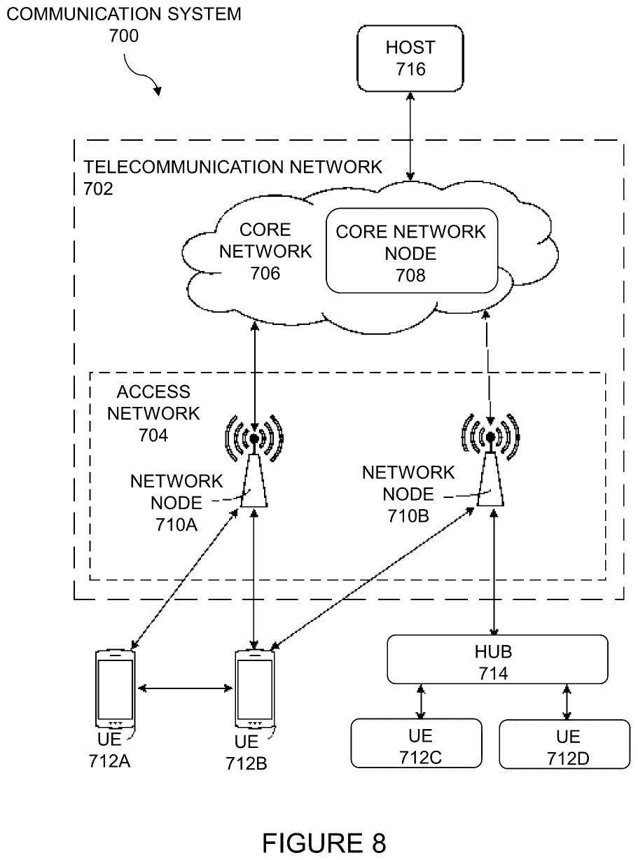

FIG. 8 shows an example of a communication system 700 in accordance with some embodiments. In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub-that is, a hub whose primary function is to route communications to/from the UEs from/to the network node 710b. In other embodiments, the hub 714 may be a non-dedicated hub-that is, a device which is capable of operating to route communications between the UEs and network node 710b, but which is additionally capable of operating as a communication start and/or end point for certain data channels.

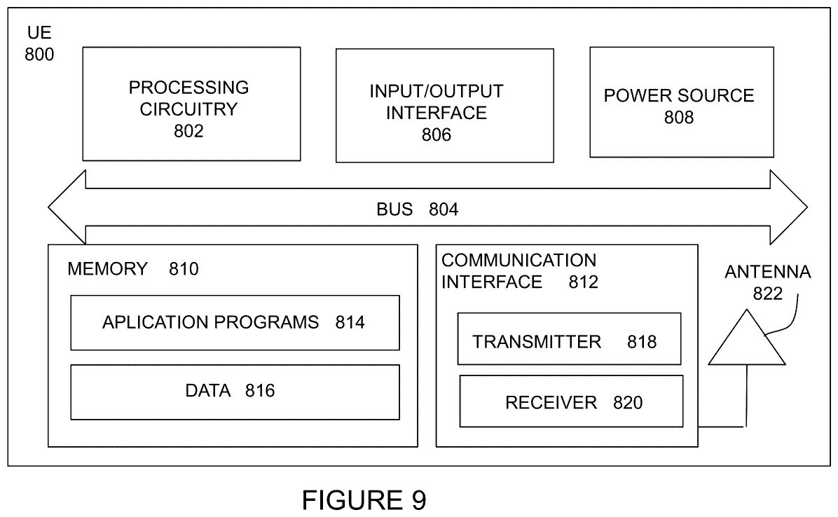

FIG. 9 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

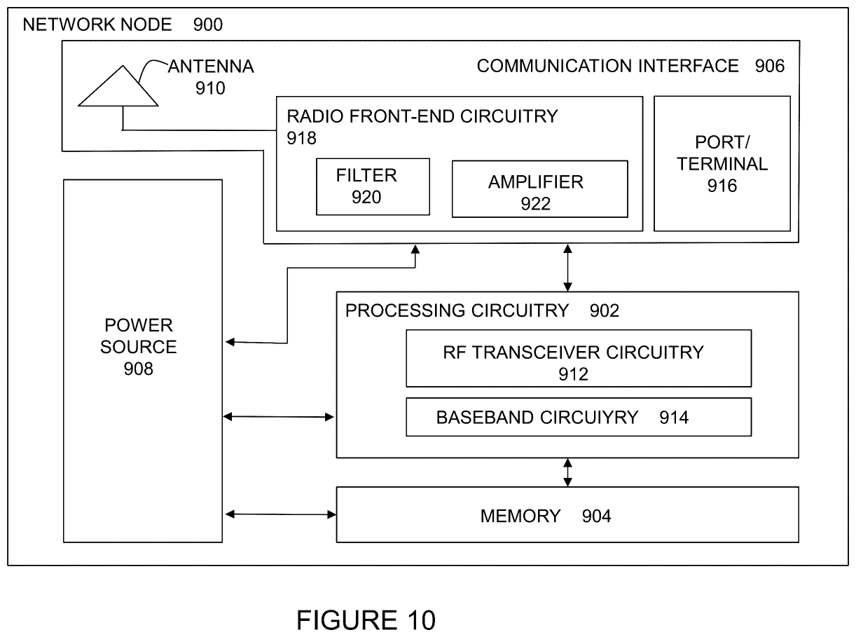

FIG. 10 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 10 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

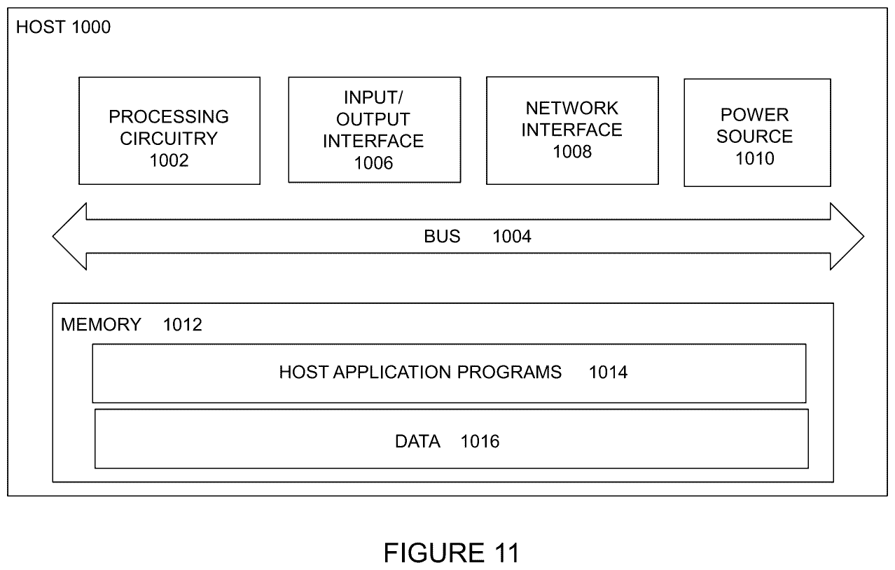

FIG. 11 is a block diagram of a host 1000, which may be an embodiment of the host 716 of FIG. 8, in accordance with various aspects described herein.

As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

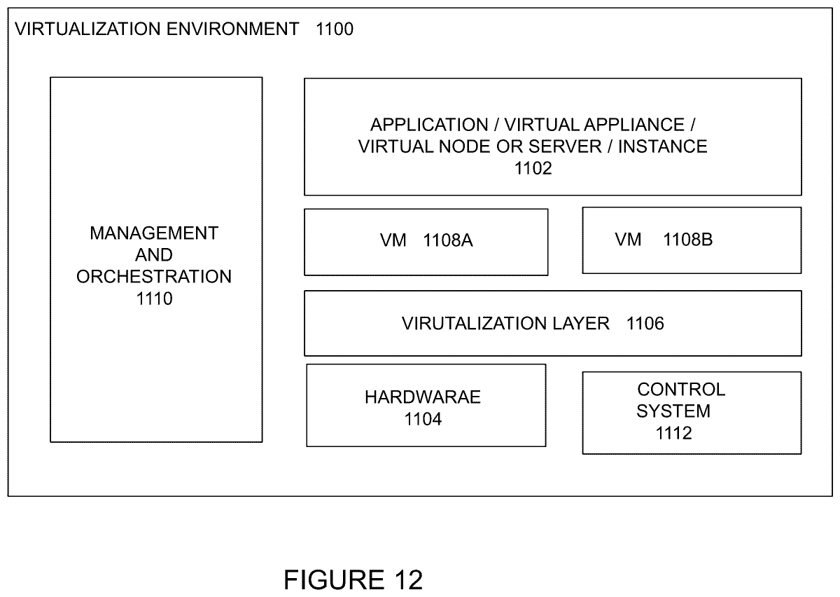

FIG. 12 is a block diagram illustrating a virtualization environment 1100 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

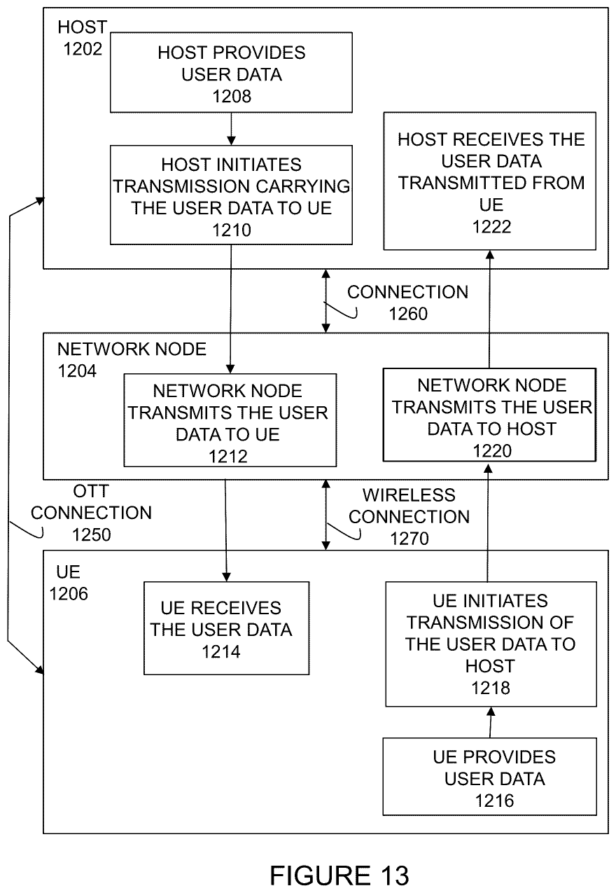

FIG. 13 shows a communication diagram of a host 1202 communicating via a network node 1204 with a UE 1206 over a partially wireless connection in accordance with some embodiments.

Example implementations, in accordance with various embodiments, of the UE (such as a UE 712a of FIG. 8 and/or UE 800 of FIG. 9), network node (such as network node 710a of FIG. 8 and/or network node 900 of FIG. 10), and host (such as host 716 of FIG. 8 and/or host 1000 of FIG. 11) discussed in the preceding paragraphs will now be described with reference to FIG. 13.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 8) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc. ; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

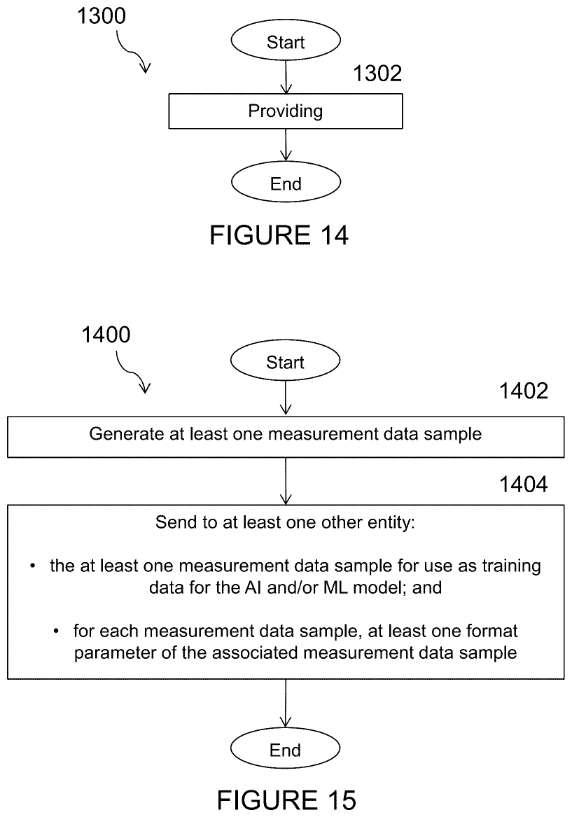

FIG. 14 illustrates an example method 1300 by a radio node for handling measurement data of different formats for an AI and/or ML model, according to certain embodiments. In the illustrated embodiment, the method includes a providing step at 1302.

For example, according to certain embodiments, a radio node operating as a signal measurement entity may provide, at step 1302 and to a training data collection entity, at least one measurement data sample for use as AI and/or ML model training data and/or, for each measurement data sample, at least one format parameter for indicating a format of the associated measurement data sample.

As another example, according to certain embodiments, a radio node operating as a training data collection entity may receive, at step 1302 and from a signal measurement entity, at least one measurement data sample for use as AI and/or ML model training data and/or, for each measurement data sample, at least one format parameter for indicating a format of the associated measurement data sample.

FIG. 15 illustrates an example method 1400 by a radio node 710 operating as a signal measurement entity for providing measurement data of different formats for an AI and/or ML model, according to certain embodiments. As illustrated, the method begins at step 1402 when the radio node 710 operating as the signal measurement entity generates at least one measurement data sample. At step 1404, the radio node 710 sends, to at least one other entity: the at least one measurement data sample for use as training data for the AI and/or ML model; and for each measurement data sample, at least one format parameter of the associated measurement data sample.

In a particular embodiment, generating the at least one measurement data sample includes receiving a radio signal and performing at least one measurement based on the radio signal.

In a particular embodiment, the at least one measurement is performed based on at least one parameter setting, the at least one parameter setting being associated with at least one of: a frequency range; a SCS of the radio signal; a bandwidth of the radio signal, a number of repetitions of the radio signal, and an Additive White Gaussian Noise and/or fading channel condition.

In a further particular embodiment, a value of the at least one format parameter is determined based on the at least one parameter setting.

In a particular embodiment, the radio node transmits, to a network node, capability information comprising at least one of: a supported frequency range; a supported maximum reference signal bandwidth, a supported number of carriers, a supported SCS, an achievable SINR with or without inference cancellation, and a UE type.

In a particular embodiment, the at least one measurement sample includes a first measurement sample associated with at least a first format parameter and a second measurement sample associated with at least a second format parameter.

In a particular embodiment, the at least one format parameter comprises at least one of: information associated with a range (Tₘᵢₙ, Tₘₐₓ) of reported values before quantization; information associated with a range (T_{q,min}, T_{q,max}) of reported values after quantization; and a resolution, k, of report mapping.

In a further particular embodiment, the at least one measurement data sample comprises at least one timing value, and wherein the resolution, k, is 2^{k}*Tc, where Tc is a defined timing unit.

In a particular embodiment, the radio node determines, by the radio node operating as the signal measurement entity, at least one of: Tₘᵢₙ; Tₘₐₓ; T_{q,min}; T_{q,max}; and the resolution, k.

In a particular embodiment, the radio node receives, from another radio node, at least one of: Tₘᵢₙ; Tₘₐₓ; T_{q,min}; T_{q,max}; and the resolution, k.

In a particular embodiment, the radio node is a UE or a gNodeB.

In a particular embodiment, the other entity comprises a training data collection entity and/or a model inference entity.

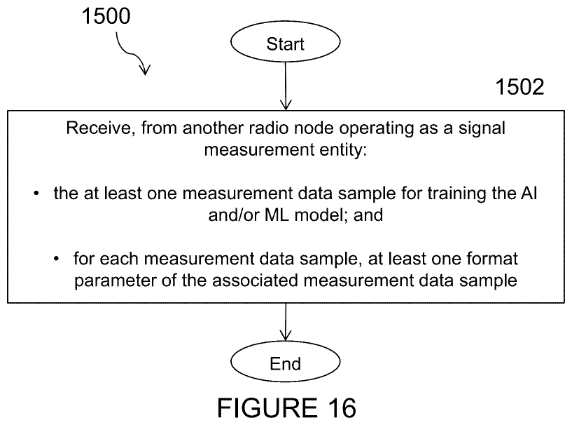

FIG. 16 illustrates an example method 1500 by a radio node 710 operating as a model inference entity, a training data collection entity, or a model training entity for receiving measurement data of different formats for an AI and/or ML model, according to certain embodiments. As illustrated, the method begins at step 1502 when the radio node 710 receives, from another radio node operating as a signal measurement entity: at least one measurement data sample for training the AI and/or ML model; and for each measurement data sample, at least one format parameter of the associated measurement data sample.

In a particular embodiment, the radio node configures the other radio node operating as the signal measurement entity.

In a particular embodiment, the radio node transmits, to the other radio node operating as the signal measurement entity at least one radio signal for performing, by the signal measurement entity, at least one measurement for generating the at least one measurement data sample.

In a particular embodiment, the at least one measurement is performed based on at least one parameter setting, the at least one parameter setting being associated with at least one of: a frequency range, a SCS of the radio signal, a bandwidth of the radio signal, a number of repetitions of the radio signal, and an Additive White Gaussian Noise and/or fading channel condition.

In a particular embodiment, a value of the at least one format parameter is determined based on the at least one parameter setting.

In a particular embodiment, the radio node receives capability information from the other radio node operating as the signal measurement entity, the capability information comprising at least one of: a supported frequency range, a supported maximum reference signal bandwidth, a supported number of carriers, a supported SCS, an achievable SINR with or without inference cancellation, and a UE type.

In a particular embodiment, a first measurement sample is associated with a first format parameter, and a second measurement sample is associated with a second format parameter.

In a particular embodiment, the radio node receives a plurality of measurement data samples, and the method includes the radio node performing at least one operation to convert the plurality of measurement data samples to a common format associated with a common format parameter or a set of common format parameters.

In a particular embodiment, performing the at least one operation comprises at least one of: resampling at least one value associated with the plurality of measurement data samples from a first sampling resolution, k, to a second sampling resolution, k_{model}, for the AI and/or ML model; and resampling at least one value associated with the plurality of measurement data samples with respect to a first Tₘᵢₙ to a second T_{model,min}, for the AI and/or ML model.

In a particular embodiment, performing the at least one operation comprises: determining an up-sampling factor, Fᵤ, and/or a down-sampling factor F_{d}; inserting between reported timing values with Fᵤ−1 zeros to obtain an intermediate up-sampled sequence; low-pass filtering the intermediate up-sampled sequence to obtain a filtered sequence; and down-sampling the filtered sequence by retaining every F_{d}-th sample from the filtered sequence.

In a particular embodiment, the at least one format parameter associated with the measurement data sample comprises at least one of: information associated with a range (Tₘᵢₙ, Tₘₐₓ) of reported values before quantization; information associated with a range (T_{q,min}, T_{q,max}) of reported values after quantization; and a resolution, k, of report mapping.

In a particular embodiment, the at least one measurement data sample comprises at least one timing value, and wherein the resolution, k, is 2^{k}*Tc. Where Tc is a defined timing unit.

In a particular embodiment, the method includes determining, by the radio node, at least one of: Tₘᵢₙ; Tₘₐₓ; T_{q,min}; T_{q,max}; and the resolution, k. The radio node sends the at least one of the Tₘᵢₙ, Tₘₐₓ, T_{q,min}, T_{q,max}, and the resolution, k, to the other node operating as the measurement entity.

In a particular embodiment, the radio node stores the at least one measurement data sample and the at least one format parameter associated with the at least one measurement data sample.

In a particular embodiment, the other radio node is a UE or gNB.

In a particular embodiment, the radio node operating as the model inference entity is a LMF.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for handling measurement data of different formats with an AI and/or ML model, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the

### Group B Example Embodiments

Example Embodiment B1. A method performed by a network node for handling measurement data of different formats with an AI and/or ML model, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a radio node operating as a signal measurement entity for handling measurement data of different formats for an AI and/or ML model, the method comprising: providing to a training data collection entity: at least one measurement data sample for use as AI and/or ML model training data; and for each measurement data sample, at least one format parameter for indicating a format of the associated measurement data sample.

Example Embodiment C2. The method of Example Embodiment C1, wherein the at least one measurement data sample comprises a offset of measurement data samples.

Example Embodiment C3. The method of Example Embodiment C2, wherein: at least a first measurement sample within the set of measurement samples is associated with at least a first format parameter, and at least a second measurement sample within the set of measurement samples is associated with at least a second format parameter.

Example Embodiment C4. The method of any one of Example Embodiments C1 to C3, comprising: receiving a radio signal; and based on at least one measurement performed on the radio signal, generating at least one measurement data sample.

Example Embodiment C5. The method of any one of Example Embodiments C1 to C4, wherein the at least one format parameter associated comprises at least one of: (a) information associated with a range (Tₘᵢₙ, Tₘₐₓ) of reported values before quantization; (b) information associated with a range (T_{q,min}, T_{q,max}) of reported values after quantization; (c) a resolution, k, of report mapping.

Example Embodiment C6. The method of Example Embodiment C5, wherein the at least one format parameter comprises at least two of (a), (b), and (c).

Example Embodiment C7. The method of Example Embodiment C5 wherein the at least one format parameter comprises only (c), and wherein (c) represents an index for determining at least one of (a) and (b).

Example Embodiment C8. The method of any one of Example Embodiments C5 to C7, wherein the information associated with the range (Tₘᵢₙ, Tₘₐₓ) of reported values before quantization indicates a first value for Tₘᵢₙ and a second value for, Tₘₐₓ).

Example Embodiment C9. The method of any one of Example Embodiments C5 to C7, wherein the information associated with the range (Tₘᵢₙ, Tₘₐₓ) of reported values before quantization comprises a first value that is associated with Tₘᵢₙ Or Tₘₐₓ, and wherein a second value for the other of Tₘᵢₙ Or Tₘₐₓ is determined based on a relationship between Tₘᵢₙ and Tₘₐₓ. Example Embodiment C10. The method of any one of Example Embodiments C5 to C9, wherein the information associated with the range (T_{q,min}, T_{q,max}) reported values after quantization indicates a third value for T_{q,min} and a fourth value for, T_{q,max}).

Example Embodiment C11. The method of any one of Example Embodiments C5 to C9, wherein the information associated with the range (T_{q,min}, T_{q,max}) of reported values after quantization comprises a first value that is associated with T_{q,min} or T_{q,max}, and wherein a second value for the other of Tamin Or Tamax is determined based on a relationship between T_{q,min} and T_{q,max}.

Example Embodiment C12. The method of any one of Example Embodiments C5 to C11, wherein the resolution, k, of report mapping comprises a quantization step size.

Example Embodiment C13. The method of Example Embodiment C5 to C12, wherein the at least one measurement data sample comprises at least one timing value, and wherein the resolution, k, is 2k*T_{c}.

Example Embodiment C14. The method of any one of Example Embodiments C5 to C13, comprising: determining, by the radio node operating as the signal measurement entity, at least one of: Tₘᵢₙ; Tₘₐₓ; T_{q,min}; T_{q,max}; and the resolution, k.

Example Embodiment C15. The method of any one of Example Embodiments C5 to C13, comprising: receiving, from another radio node, at least one of: Tₘᵢₙ; Tₘₐₓ; T_{q,min}; T_{q,max}; and the resolution, k.

Example Embodiment C16. The method of any one of Example Embodiments C1 to C15, wherein: the radio node is a UE, the signal measurement entity is associated with the UE, and the training data collection entity is associated with the UE.

Example Embodiment C17. The method of any one of Example Embodiments C1 to C15, wherein: the radio node is a UE, the signal measurement entity is associated with the UE, and the training data collection entity is associated with another radio node, which comprises another UE or a network node.

Example Embodiment C18. The method of any one of Example Embodiments C1 to C15, wherein: the radio node is a network node, the signal measurement entity is associated with the network node, and the training data collection entity is associated with the network node.

Example Embodiment C19. The method of any one of Example Embodiments C1 to C15, wherein: the radio node is a network node, the signal measurement entity is associated with the network node, and the training data collection entity is associated with another radio node, which comprises a UE or another network node.

Example Embodiment C20. The method of any one of Example Embodiments C1 to C19, further comprising: providing user data; and forwarding the user data to a host via the transmission to a network node.

Example Embodiment C21. The method of any one of Example Embodiments C1 to C19, further comprising: obtaining user data; and forwarding the user data to a host or a user equipment.

Example Embodiment C22. A radio node comprising processing circuitry configured to perform any of the methods of Example Embodiments C1 to C21.

Example Embodiment C23. A radio node configured to perform any of the methods of Example Embodiments C1 to C21.

Example Embodiment C24. A computer program comprising instructions which when executed on a computer perform any of the methods of Example Embodiments C1 to C21.

Example Embodiment C25. A computer program product comprising computer program, the computer program comprising instructions which when executed on a computer perform any of the methods of Example Embodiments C1 to C21.

Example Embodiment C26.A non-transitory computer readable medium storing instructions which when executed by a computer perform any of the methods of Example Embodiments C1 to C21.

Example Embodiment D1. A method by a radio node operating as a training data collection entity for handling measurement data of different formats for an AI and/or ML model for an AI and/or ML model, the method comprising: receiving from a signal measurement entity: at least one measurement data sample for use as AI and/or ML model training data; and for each measurement data sample, at least one format parameter for indicating a format of the associated measurement data sample.

Example Embodiment D2. The method of Example Embodiment D1, wherein: the at least one measurement data sample comprises a set of measurement data samples.

Example Embodiment D3. The method of Example Embodiment D2, wherein: at least a first measurement sample within the set of measurement samples is associated with at least a first format parameter, and at least a second measurement sample within the set of measurement samples is associated with at least a second format parameter.

Example Embodiment D4. The method of Example Embodiment D3, comprising performing at least one operation to convert the set of measurement samples to a common format associated with a common format parameter or set of common format parameters associated with the AI and/or ML model.

Example Embodiment D5. The method of Example Embodiment D4, wherein performing the at least one operation comprises at least one of: resampling at least one value associated with the set of measurement samples from a first sampling resolution, k, to a second sampling resolution, k_{model}, for the AI and/or ML model; and resampling at least one value associated with the set of measurement samples with respect to a first Tₘᵢₙ to a second T_{model,min}, for the AI and/or ML model.

Example Embodiment D6. The method of any one of Example Embodiments D4 to D5,wherein performing the at least one operation comprises at least one of: determining an up-sampling factor, Fu, and/or a down-sampling factor Fa; inserting between reported timing values with Fᵤ−1 zeros to obtain an intermediate up-sampled sequence; low-pass filtering the intermediate up-sampled sequence to obtain a filtered sequence; and down-sampling the filtered sequence by retaining every F_{d}-th sample from the filtered sequence.

Example Embodiment D7. The method of any one of Example Embodiments D1 to D6, wherein the at least one format parameter associated with the measurement data sample comprises at least one of: (a) information associated with a range (Tₘᵢₙ, Tₘₐₓ) of reported values before quantization; (b) information associated with a range (T_{q,min}, T_{q,max}) of reported values after quantization; and (c) a resolution, k, of report mapping.

Example Embodiment D8. The method of Example Embodiment D7, wherein the at least one format parameter comprises at least two of (a), (b), and (c).

Example Embodiment D9. The method of Example Embodiment D7, wherein the at least one format parameter comprises only (c), and wherein (c) represents an index for determining at least one of (a) and (b).

Example Embodiment D10. The method of Example Embodiment D9, comprising determining (a) and (b) based on (c).

Example Embodiment D11. The method of any one of Example Embodiments D7 to D10, wherein the information associated with the range (Tₘᵢₙ, Tₘₐₓ) of reported values before quantization indicates a first value for Tₘᵢₙ and a second value for, Tₘₐₓ).

Example Embodiment D12. The method of any one of Example Embodiments D7 to D10, wherein the information associated with the range (Tₘᵢₙ, Tₘₐₓ) of reported values before quantization comprises a first value that is associated with Tₘᵢₙ or Tₘₐₓ, and wherein a second value for the other of Tₘᵢₙ Or Tₘₐₓ is determined based on a relationship between Tₘᵢₙ and Tₘₐₓ. Example Embodiment D13. The method of any one of Example Embodiments D7 to D12, wherein the information associated with the range (T_{q,min}, T_{q,max}) reported values after quantization indicates a third value for T_{q,min} and a fourth value for, T_{q,max}).

Example Embodiment D14. The method of any one of Example Embodiments D7 to D12, wherein the information associated with the range (T_{q,min}, T_{q,max}) of reported values after quantization comprises a first value that is associated with T_{q,min} or T_{q,max}, and wherein a second value for the other of T_{q,min} Or T_{q,max} is determined based on a relationship between T_{q,min} and T_{q,max}.

Example Embodiment D15. The method of any one of Example Embodiments D7 to D14, wherein the resolution, k, of report mapping comprises a quantization step size.

Example Embodiment D16. The method of Example Embodiment D7 to D15, wherein the at least one measurement data sample comprises at least one timing value, and wherein the resolution, k, is 2^{k}*Tc.

Example Embodiment D17. The method of any one of Example Embodiments D7 to D16, comprising: determining, by the radio node operating as the training data collection entity, at least one of: Tₘᵢₙ; Tₘₐₓ; T_{q,min}; T_{q,max}; and the resolution, k.

Example Embodiment D18. The method of any one of Example Embodiments D1 to D17, comprising storing the at least one measurement data sample and the at least one format parameter associated with the at least one measurement data sample.

Example Embodiment D19. The method of any one of Example Embodiments D1 to D18, wherein: the radio node is a UE, the training data collection entity is associated with the UE, and the signal measurement entity is associated with the UE.

Example Embodiment D20. The method of any one of Example Embodiments D1 to D18, wherein: the radio node is a UE, the training data collection entity is associated with the UE, and the signal measurement entity is associated with another radio node, which comprises another UE or a network node.

Example Embodiment D21. The method of any one of Example Embodiments D1 to D18, wherein: the radio node is a network node, the training data collection entity is associated with the network node, and the signal measurement entity is associated with the network node.

Example Embodiment D22. The method of any one of Example Embodiments D1 to D18, wherein: the radio node is a network node, the training data collection entity is associated with the network node, and the signal measurement entity is associated with another radio node, which comprises a UE or another network node.

Example Embodiment D23. The method of any one of Example Embodiments D1 to D22, further comprising: providing user data; and forwarding the user data to a host via the transmission to a network node.

Example Embodiment D24. The method of any one of Example Embodiments D1 to D22, further comprising: obtaining user data; and forwarding the user data to a host or a user equipment.

Example Embodiment D25. A radio node comprising processing circuitry configured to perform any of the methods of Example Embodiments D1 to D24.

Example Embodiment D26. A radio node configured to perform any of the methods of Example Embodiments D1 to D24.

Example Embodiment D27. A computer program comprising instructions which when executed on a computer perform any of the methods of Example Embodiments D1 to D24.

Example Embodiment D28. A computer program product comprising computer program, the computer program comprising instructions which when executed on a computer perform any of the methods of Example Embodiments D1 to D24.

Example Embodiment D29. A non-transitory computer readable medium storing instructions which when executed by a computer perform any of the methods of Example Embodiments D1 to D24.

### Group E Example Embodiments

Example Embodiment E1. A method by a radio node operating as a model training entity for handling measurement data of different formats for an AI and/or ML model for an AI and/or ML model, the method comprising: receiving from a training data collection entity and/or a signal measurement entity: at least one measurement data sample for use as AI and/or ML model training data; and for each measurement data sample, at least one format parameter for indicating a format of the associated measurement data sample.

Example Embodiment E2. The method of Example Embodiment E1, wherein: the at least one measurement data sample comprises a set of measurement data samples.

Example Embodiment E3. The method of Example Embodiment E2, wherein: at least a first measurement sample within the set of measurement samples is associated with at least a first format parameter, and at least a second measurement sample within the set of measurement samples is associated with at least a second format parameter.

Example Embodiment E4. The method of Example Embodiment E3, comprising at least one of: performing at least one operation to convert the set of measurement samples to a common format associated with a common format parameter or set of common format parameters associated with the AI and/or ML model; and inputting the converted set of measurement samples in the common format into the AI and/or ML model to train the AI and/or ML model.

Example Embodiment E5. The method of Example Embodiment E4, wherein performing the at least one operation comprises at least one of: resampling at least one value associated with the set of measurement samples from a first sampling resolution, k, to a second sampling resolution, k_{model}, for the AI and/or ML model; and resampling at least one value associated with the set of measurement samples with respect to a first Tₘᵢₙ to a second T_{model,min}, for the AI and/or ML model.

Example Embodiment E6. The method of any one of Example Embodiments E4 to E5,wherein performing the at least one operation comprises at least one of: determining an up-sampling factor, Fᵤ, and/or a down-sampling factor Fa; inserting between reported timing values with Fᵤ−1 zeros to obtain an intermediate up-sampled sequence; low-pass filtering the intermediate up-sampled sequence to obtain a filtered sequence; and down-sampling the filtered sequence by retaining every F_{d}-th sample from the filtered sequence.

Example Embodiment E7. The method of any one of Example Embodiments E1 to E6, wherein the at least one format parameter associated with the measurement data sample comprises at least one of: (a) information associated with a range (Tₘᵢₙ, Tₘₐₓ) of reported values before quantization; (b) information associated with a range (T_{q,min}, T_{q,max}) of reported values after quantization; (c) a resolution, k, of report mapping.

Example Embodiment E8. The method of Example Embodiment E7, wherein the at least one format parameter comprises at least two of (a), (b), and (c).

Example Embodiment E9. The method of Example Embodiment E7, wherein the at least one format parameter comprises only (c), and wherein (c) represents an index for determining at least one of (a) and (b).

Example Embodiment E10. The method of Example Embodiment E9, comprising determining (a) and (b) based on (c).

Example Embodiment E11. The method of any one of Example Embodiments E7 to E10, wherein the information associated with the range (Tₘᵢₙ, Tₘₐₓ) of reported values before quantization indicates a first value for Tₘᵢₙ and a second value for, Tₘₐₓ).

Example Embodiment E12. The method of any one of Example Embodiments E7 to E10, wherein the information associated with the range (Tₘᵢₙ, Tₘₐₓ) of reported values before quantization comprises a first value that is associated with Tₘᵢₙ or Tₘₐₓ, and wherein a second value for the other of Tₘᵢₙ Or Tₘₐₓ is determined based on a relationship between Tₘᵢₙ and Tₘₐₓ. Example Embodiment E13. The method of any one of Example Embodiments E7 to E12,wherein the information associated with the range (T_{q,min}, T_{q,max}) reported values after quantization indicates a third value for T_{q,min} and a fourth value for, T_{q,max}).

Example Embodiment E14. The method of any one of Example Embodiments E7 to E12, wherein the information associated with the range (T_{q,min}, T_{q,max}) of reported values after quantization comprises a first value that is associated with T_{q,min} or T_{q,max}, and wherein a second value for the other of T_{q,min} or T_{q,max} is determined based on a relationship between T_{q,min} and T_{q,max}.

Example Embodiment E15. The method of any one of Example Embodiments E7 to E14, wherein the resolution, k, of report mapping comprises a quantization step size.

Example Embodiment E16. The method of Example Embodiment E7 to E15, wherein the at least one measurement data sample comprises at least one timing value, and wherein the resolution, k, is 2^{k}*Tc.

Example Embodiment E17. The method of any one of Example Embodiments E7 to E16, comprising: determining, by the radio node operating as the training data collection entity, at least one of: Tₘᵢₙ; Tₘₐₓ; T_{q,min}; T_{q,max}; and the resolution, k.

Example Embodiment E18. The method of any one of Example Embodiments E1 to E17, comprising storing the at least one measurement data sample and the at least one format parameter associated with the at least one measurement data sample.

Example Embodiment E19. The method of any one of Example Embodiments E1 to E18, wherein: the radio node is a UE, the model training entity is associated with the UE, and the training data collection entity and/or the signal measurement entity is associated with the UE.

Example Embodiment E20. The method of any one of Example Embodiments E1 to E18, wherein: the radio node is a UE, the model training entity is associated with the UE, and the training data collection entity and/or the signal measurement entity is associated with another radio node, which comprises another UE or a network node.

Example Embodiment E21. The method of any one of Example Embodiments E1 to E18, wherein: the radio node is a network node, the model training entity is associated with the network node, and the training data collection entity and/or the signal measurement entity is associated with the network node.

Example Embodiment E22. The method of any one of Example Embodiments E1 to E18, wherein: the radio node is a network node, the model training entity is associated with the network node, and the training data collection entity and/or the signal measurement entity is associated with another radio node, which comprises a UE or another network node.

Example Embodiment E23. The method of any one of Example Embodiments E1 to E22, further comprising: providing user data; and forwarding the user data to a host via the transmission to a network node.

Example Embodiment E24. The method of any one of Example Embodiments E1 to E22, further comprising: obtaining user data; and forwarding the user data to a host or a user equipment. Example Embodiment E25. A radio node comprising processing circuitry configured to perform any of the methods of Example Embodiments E1 to E24.

Example Embodiment E26. A radio node configured to perform any of the methods of Embodiments E1 to E24.

Example Embodiment E27. A computer program comprising instructions which when executed on a computer perform any of the methods of Example Embodiments E1 to E24.

Example Embodiment E28. A computer program product comprising computer program, the computer program comprising instructions which when executed on a computer perform any of the methods of Example Embodiments E1 to E24.

Example Embodiment E29. A non-transitory computer readable medium storing instructions which when executed by a computer perform any of the methods of Example Embodiments E1 to E24.

### Group F Example Embodiments

Example Embodiment F1. A user equipment for handling measurement data of different formats for an AI and/or ML model, the UE comprising: processing circuitry configured to perform any of the steps of any of the Group A, C, D, and E Example Embodiments; and power supply circuitry configured to supply power to the processing circuitry.

Example Embodiment F2. A network node for handling measurement data of different formats for an AI and/or ML model, the network node comprising: processing circuitry configured to perform any of the steps of any of the Group B, C, D, and E Example Embodiments; power supply circuitry configured to supply power to the processing circuitry.

Example Embodiment F3. A user equipment (UE) for handling measurement data of different formats for an AI and/or ML model, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A, C, D, and E Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment F4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, C, D, and E Example Embodiments to receive the user data from the host.

Example Embodiment F5. The host of the previous Example Embodiment, wherein the cellular network further includes a network node configured to communicate with the UE to transmit the user data to the UE from the host.

Example Embodiment F6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment F8. The method of the previous Example Embodiment, further comprising: at the host, executing a host application associated with a client application executing on the UE to receive the user data from the UE.

Example Embodiment F9. The method of the previous Example Embodiment, further comprising: at the host, transmitting input data to the client application executing on the UE, the input data being provided by executing the host application, wherein the user data is provided by the client application in response to the input data from the host application.

Example Embodiment F10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, C, D, and E Example Embodiments to transmit the user data to the host.

Example Embodiment F11. The host of the previous Example Embodiment, wherein the cellular network further includes a network node configured to communicate with the UE to transmit the user data from the UE to the host.

Example Embodiment F12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F13. A method implemented by a host configured to operate in a communication system that further includes a network node and a user equipment (UE), the method comprising: at the host, receiving user data transmitted to the host via the network node by the UE, wherein the UE performs any of the steps of any of the Group A, C, D, and E Example Embodiments to transmit the user data to the host.

Example Embodiment F14. The method of the previous Example Embodiment, further comprising: at the host, executing a host application associated with a client application executing on the UE to receive the user data from the UE.

Example Embodiment F15. The method of the previous Example Embodiment, further comprising: at the host, transmitting input data to the client application executing on the UE, the input data being provided by executing the host application, wherein the user data is provided by the client application in response to the input data from the host application.

Example Embodiment F16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, C, D, and E Example Embodiments to transmit the user data from the host to the UE.

Example Embodiment F17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment F18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, C, D, and E Example Embodiments to transmit the user data from the host to the UE.

Example Embodiment F19. The method of the previous Example Embodiment, further comprising, at the network node, transmitting the user data provided by the host for the UE.

Example Embodiment F20. The method of any of the previous 2 Example Embodiments, wherein the user data is provided at the host by executing a host application that interacts with a client application executing on the UE, the client application being associated with the host application.

Example Embodiment F21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, C, D, and E Example Embodiments to transmit the user data from the host to the UE.

Example Embodiment F22. The communication system of the previous Example Embodiment, further comprising: the network node; and/or the user equipment.

Example Embodiment F23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, C, D, and E Example Embodiments to receive the user data from a user equipment (UE) for the host.

Example Embodiment F24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F25. The host of the any of the previous 2 Example Embodiments, wherein the initiating receipt of the user data comprises requesting the user data.

Example Embodiment F26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, C, D, and E Example Embodiments to receive the user data from the UE for the host.

Example Embodiment F27. The method of the previous Example Embodiment, further comprising at the network node, transmitting the received user data to the host.

1. A method by a radio node operating as a signal measurement entity for providing measurement data of different formats for an Artificial Intelligence, AI, and/or Machine Learning, ML, model, the method comprising:
generating at least one measurement data sample; and
sending to at least one other entity:
the at least one measurement data sample for use as training data for the AI and/or ML model; and
for each measurement data sample, at least one format parameter of the associated measurement data sample.

2. The method of claim 1, wherein generating the at least one measurement data sample comprises:
receiving a radio signal; and
performing at least one measurement based on the radio signal.

3. The method of claim 2, wherein the at least one measurement is performed based on at least one parameter setting, the at least one parameter setting being associated with at least one of:
a frequency range,
a Subcarrier Spacing, SCS, of the radio signal,
a bandwidth of the radio signal,
a number of repetitions of the radio signal, and
an Additive White Gaussian Noise and/or fading channel condition.

4. The method of claim 3, wherein a value of the at least one format parameter is determined based on the at least one parameter setting.

5. The method of claim 1, comprising transmitting, to a network node, capability information comprising at least one of:
a supported frequency range;
a supported maximum reference signal bandwidth,
a supported number of carriers,
a supported Subcarrier Spacing, SCS,
an achievable Signal Interference to Noise Ratio, SINR, with or without inference cancellation, and
a UE type.

6. The method of claim 1, wherein the at least one measurement sample comprises:
a first measurement sample associated with at least a first format parameter, and
a second measurement sample associated with at least a second format parameter.

7. The method of claim 1, wherein the at least one format parameter comprises at least one of:
information associated with a range (Tₘᵢₙ, Tₘₐₓ) of reported values before quantization;
information associated with a range (T_{q,min}, T_{q,max}) of reported values after quantization; and
a resolution, k, of report mapping.

8. The method of claim, wherein the at least one measurement data sample comprises at least one timing value, and wherein the resolution, k, is 2^{k}*T_{c}, where Tc is a defined timing unit.

9. The method of claim 5, comprising determining, by the radio node operating as the signal measurement entity, at least one of:
Tₘᵢₙ;
Tₘₐₓ;
T_{q,min};
T_{q,max}; and
the resolution, k.

10. The method of claim 7, comprising receiving, from another radio node, at least one of:
Tₘᵢₙ;
Tₘₐₓ;
T_{q,min};
T_{q,max}; and
the resolution, k.

11. The method of claim 1, wherein:
the radio node is a UE or a gNodeB.

12. The method of claim 1, wherein the other entity comprises a training data collection entity and/or a model inference entity.

13. A method by a radio node operating as a model inference entity, a training data collection entity, or a model training entity for receiving measurement data of different formats for an Artificial Intelligence, AI, and/or Machine Learning, ML, model, the method comprising:
receiving, from another radio node operating as a signal measurement entity:
at least one measurement data sample for training the AI and/or ML model; and
for each measurement data sample, at least one format parameter of the associated measurement data sample.

14. The method of claim, wherein the radio node configures the other radio node operating as the signal measurement entity.

15. The method of claim 13, comprising transmitting, to the other radio node operating as the signal measurement entity at least one radio signal for performing, by the signal measurement entity, at least one measurement for generating the at least one measurement data sample.

16. The method of claim, wherein the at least one measurement is performed based on at least one parameter setting, the at least one parameter setting being associated with at least one of:
a frequency range,
a Subcarrier Spacing, SCS, of the radio signal,
a bandwidth of the radio signal,
a number of repetitions of the radio signal, and
an Additive White Gaussian Noise and/or fading channel condition.

17. The method of claim, wherein a value of the at least one format parameter is determined based on the at least one parameter setting.

18. The method of claim 13, comprising receiving capability information from the other radio node operating as the signal measurement entity, the capability information comprising at least one of:
a supported frequency range;
a supported maximum reference signal bandwidth,
a supported number of carriers,
a supported Subcarrier Spacing, SCS,
an achievable Signal Interference to Noise Ratio, SINR, with or without inference cancellation, and
a UE type.

19. The method of claim 13, wherein:
a first measurement sample is associated with a first format parameter, and
a second measurement sample is associated with a second format parameter.

20. The method of claim 13, wherein the radio node receives a plurality of measurement data samples, and the method comprises performing at least one operation to convert the plurality of measurement data samples to a common format associated with a common format parameter or a set of common format parameters.

21. The method of claim, wherein performing the at least one operation comprises at least one of:
resampling at least one value associated with the plurality of measurement data samples from a first sampling resolution, k, to a second sampling resolution, k_{model}, for the AI and/or ML model; and
resampling at least one value associated with the plurality of measurement data samples with respect to a first Tₘᵢₙ to a second T_{model,min}, for the AI and/or ML model.

22. The method of clai, 20, wherein performing the at least one operation comprises:
determining an up-sampling factor, Fᵤ, and/or a down-sampling factor F_{d};
inserting between reported timing values with Fᵤ−1 zeros to obtain an intermediate up-sampled sequence;
low-pass filtering the intermediate up-sampled sequence to obtain a filtered sequence; and
down-sampling the filtered sequence by retaining every F_{d}-th sample from the filtered sequence.

23.-28. (canceled)

29. A radio node operating as a signal measurement entity for providing measurement data of different formats for an Artificial Intelligence, AI, and/or Machine Learning, ML, model, the radio node configured to:
generate at least one measurement data sample; and
send to at least one other entity:
at least one measurement data sample for use as training data for the AI and/or ML model; and
for each measurement data sample, at least one format parameter of the associated measurement data sample.

30. (canceled)

31. A radio node operating as a model inference entity, a training data collection entity, or a model training entity for receiving measurement data of different formats for an Artificial Intelligence, AI, and/or Machine Learning, ML, model, the radio node configured to:
receive from another node operating as a signal measurement entity:
at least one measurement data sample for training the AI and/or ML model; and
for each measurement data sample, at least one format parameter of the associated measurement data sample.

32. (canceled)
